(19) United States
(12) Patent Application Publication
(10) Pub. No.: US 2007/0263477 A1
(43) Pub. Date: Nov. 15, 2007

(54) Method for mixing fluids in microfluidic channels

(75) Inventors: Arjun P. Sudarsan, Durham, NC (US); Victor M. Ugaz, College Station, TX (US)

Correspondence Address: GARDERE WYNNE-HOUSTON, 1000 LOUISIANA, SUITE 3400, HOUSTON, TX, 77002, US

(73) Assignee: The Texas A&M University System, College Station, TX (US)

(21) Appl. No.: 11/801,440

(22) Filed: May 10, 2007

Related U.S. Application Data
(60) Provisional application No. 60/799,537, filed on May 11, 2006.
(60) Provisional application No. 60/835,032, filed on Aug. 2, 2006.

(51) Int. Cl. B28C 5/06

(52) U.S. Cl. 366/3

(57) ABSTRACT

Methods and apparatus are provided for mixing fluids. In one embodiment of the invention, a fluid mixer is provided including one or more fluid inlet ports, a curved channel connected to the one or more fluid inlet ports including a first curved channel section and a second curved channel section disposed adjacent the first curved channel section, and an outlet port disposed adjacent the second curved channel section. In another embodiment of the invention, a method is provided for mixing fluids in a channel, including providing a channel having a first curved channel section, and a second curved channel section, providing the two or more parallel fluid streams into the second curved channel section of the channel, mixing the two or more parallel fluid streams in the first curved channel section of the channel, and mixing the two or more parallel fluid streams in the second curved channel section of the channel.

### CROSS-REFERENCES TO RELATED APPLICATIONS

This application claims benefit of U.S. Provisional Patent Application Ser. No. 60/799,537, filed on May 11, 2006, and U.S. Provisional Patent Application Ser. No. 60/835,032, filed on Aug. 2, 2006, each of which are incorporated herein by reference.

### STATEMENT REGARDING FEDERALLY SPONSORED RESEARCH OR DEVELOPMENT

The patent application is supported by the National Institutes of Health under grant NIH k22-HG02297.

### REFERENCE TO A SEQUENTIAL LISTING

None.

### BACKGROUND OF THE INVENTION

1. Field of the Invention

The present invention relates to fluid processing. In particular, the present invention relates to mixing fluids in channels.

2. Background of the Art

Microfluidics is becoming an increasingly important and mainstream technology in many chemical and biological process and analysis applications. The potential to replace large-scale conventional laboratory instrumentation with miniaturized and self-contained systems offers a variety of advantages that include reduced hardware costs, low reagent consumption, faster analysis speeds, and the capability of operating in a massively parallel scale in order to achieve high-throughput. For this technology to be successfully employed in Micro Total Analysis Systems (MTAS) research, the ability to rapidly mix two or more reagent streams in a small device footprint is required.

Microfluidic mixing is a key process in a host of miniaturized analysis systems. However, microfluidic mixing is difficult to perform as the process is usually limited to an unfavorable laminar flow regime dominated by molecular diffusion and characterized by a combination of low Reynolds numbers (Re=Vd/v<<100, where V is the fluid flow velocity, d is a length scale associated with the channel diameter, and v is the fluid kinematic viscosity) and high Péclet numbers (Pe=Vd/D>100, where D is the molecular diffusivity). Typically, flow in micro-scale conduits is laminar with Reynolds numbers well below the threshold for turbulence (Re=Vd/v<100) leaving molecular diffusion as the predominant driving force for mixing to occur. Furthermore, the high Péclet numbers in microchannels (Pe Vd/Dₘₒₗ>100, where Dₘₒₗ is the molecular diffusivity), indicate that diffusive mixing occurs at a much slower rate than the timescales associated with fluid motion. These factors combine to produce characteristic mixing lengths (Δyₘ−V*(d²/D)=Pe*d) on the order of several centimeters, resulting in the need to employ cumbersomely long channels in order to achieve complete mixing. These mixing lengths axe generally prohibitively long and often negate many of the benefits of miniaturization.

In general, mixing strategies can be classified as either active or passive, depending on the operational mechanism. Active mixers employ external forces, beyond the energy associated with the fluid flow, in order to perform mixing. Some examples of techniques developed to accomplish this include, for example, electro-osmosis, magnetic stirring, bubble-induced acoustic actuation, and ultrasonic effects. While generally effective, these designs are often not easy to integrate with other microfluidic components and typically add substantial complexity to the fabrication process. Moreover, since high electric fields, mechanical shearing, or generation of nontrivial amounts of heat are involved, they are not well suited for use with sensitive species (e.g., biological samples).

Passive designs are often desirable in applications involving sensitive species (e.g., biological samples) because they do not impose strong mechanical, electrical, or thermal agitation. Examples of passive micromixing approaches that have been widely investigated include lamination-based (“split-and-recombine”) strategies where the streams to be mixed are divided or split into multiple channels and redirected along trajectories that allow them to be subsequently reassembled and passive rotation (“chaotic”) strategies where transverse flows are passively generated that continuously expand interfacial area between species through stretching, folding, and breakup processes. The microchannel structures associated with these mixing elements range from relatively simple topological features on one or more channel walls (ridges, grooves, or other protrusions that can, for example, be constructed by means of multiple soft lithography, alignment, and bonding steps) to intricate 3D (three dimensional) flow networks requiring timescales on the order hours to days to construct, often with expensive specialized equipment, and are generally impractical for mass production or routine use. Additionally, attempts to provide mixing in 2D flow networks have not been successful as the corresponding Re in these experiments is fairly large (Re>>100) and outside the range of conditions that are realistically achievable in most microfluidic systems.

A variety of designs, such as variations of helical and “twisted pipe” arrangements have been investigated to enhance mixing in microfluidic systems; however, the corresponding nonplanar flow geometries often require multilevel or specialized fabrication processes that can introduce added complexity. Conversely, the design of planar microchannels capable of sustaining transverse circulation over a sufficient downstream distance to compensate for the incompatibility between flow and diffusion timescales also has proven challenging.

Accordingly, there is a need for microfluidic mixers and processes for forming the same.

### BRIEF SUMMARY OF THE INVENTION

In one embodiment of the invention, a fluid mixer is provided including one or more fluid inlet ports, a curved channel connected to the one or more fluid inlet ports including a first curved channel section and a second curved channel section disposed adjacent the first curved channel section, and an outlet port disposed adjacent the second curved channel section. In another embodiment of the invention, the second curved channel section comprises two or more sub-channels. In another embodiment of the invention, the second curved channel section has a width greater than the width of the first curved channel section.

In another embodiment of the invention, a method is provided for mixing fluids in a channel, including providing a channel having a first curved channel section, and a second curved channel section, providing the two or more parallel fluid streams into the second curved channel section of the channel, mixing the two or more parallel fluid streams in the first curved channel section of the channel, and mixing the two or more parallel fluid streams in the second curved channel section of the channel. In another embodiment, the providing a first parallel fluid stream and a second parallel fluid stream to the channel by the one or more fluid inlet ports includes providing the first parallel fluid stream adjacent the inner channel wall and providing the second parallel fluid stream adjacent the outer channel wall. In another embodiment, mixing the two or more parallel fluid streams in the first curved channel section of the channel includes inducing at least a 90° rotation to the first parallel fluid stream and the second parallel fluid stream in the upper channel half of the first curved channel section and inducing at least a 90° counter rotation to the first parallel fluid stream and the second parallel fluid stream in the lower channel half of the first curved channel section. In another embodiment, mixing the two or more parallel fluid streams in the second curved channel section of the channel includes inducing at least a 90° rotation to the first parallel fluid stream and the second parallel fluid stream in the upper channel half of the second curved channel section and inducing at least a 90° counter rotation to the first parallel fluid stream and the second parallel fluid stream in the lower channel half of the second curved channel section.

In another embodiment of the invention, mixing the two or more parallel fluid streams in the second curved channel section of the channel includes providing the two parallel fluid streams to the two or more sub-channels, inducing at least a 90° rotation to the first parallel fluid stream and the second parallel fluid stream in an upper channel half of each of the two or more sub-channels, inducing at least a 90° counter rotation to the first parallel fluid stream and the second parallel fluid stream in a lower channel half of each of the two or more sub-channels and recombining the two or more sub-channels into an outlet port.

In another embodiment of the invention, mixing the two or more parallel fluid streams in the second curved channel section of the channel includes providing the two parallel fluid streams to the second curved channel section, exposing the two parallel fluid streams to expansion vortices, inducing at least a 90° rotation to the first parallel fluid stream and the second parallel fluid stream in the upper channel half of the second curved channel section, and inducing at least a 90° counter rotation to the first parallel fluid stream and the second parallel fluid stream in the lower channel half of the second curved channel section.

In another embodiment of the invention, a fluid mixer is provided, including one or more fluid inlet ports, a channel section connected to the one or more fluid inlet ports, the channel section including, an inlet arc section connected to the one or more inlet ports, a transition section connected to the inlet arc section, an outlet arc section connected to the transition section, and an outlet port connected to the outlet arc section.

### BRIEF DESCRIPTION OF THE DRAWINGS

For more complete understanding of the features and advantages of the present invention, reference is now made to the detailed description of the invention along with the accompanying Figures, wherein:

FIGS. 1A-1B is a schematic perspective view of one embodiment of the fluid mixer with fluid streams in different regimes;

FIGS. 2A-2C are schematic perspective and top views of additional embodiments of the fluid mixer;

FIG. 3, is a schematic perspective view of one embodiment a channel;

FIGS. 4A-4B are schematic perspective views of another embodiment of the fluid mixer;

FIGS. 5A-5B are schematic views of another embodiment of the fluid mixer;

FIGS. 6A-6D are schematic views of additional embodiments of the fluid mixer; and

FIGS. 7A-7B are charts illustrating one embodiment of a channel parameter relationship.

### DETAILED DESCRIPTION OF THE INVENTION

The present invention relates to the formation of microfluidic mixers and processes for mixing fluids therein. In one embodiment of a fluid mixer, the fluid mixer includes one or more fluid inlet ports, a curved channel connected to the one or more fluid inlet ports, with the curved channel having a first curved channel section and a second curved channel section disposed adjacent the first curved channel section, and an outlet port disposed adjacent the second curved channel section. Multiple curved channels may be connected in sequence with the preferred configuration having each subsequent curved channel having a curvature opposition of the prior channel.

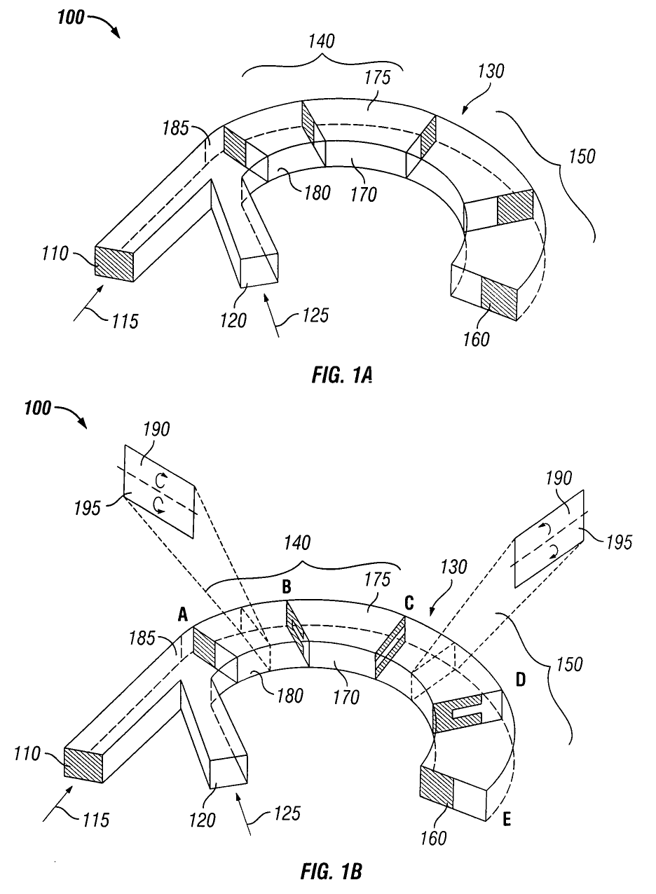

FIG. 1 is a schematic perspective view of one embodiment of the fluid mixer 100 comprising a first inlet port 110 and a second inlet port 120 for providing a respective first fluid 115, shown as shaded, and a respective second fluid 125 to a channel 130 having two or more curved sections, such as a first curved channel section 140 and a second curved section 150. The one or more inlet ports generally have an aggregate width matching the width of the channel 130. The channel 130 further comprises an inner wall 170 and an outer wall 175 defining a width, and a bottom 180 and a top 185 defining a height. The channel may be further defined as having an upper half section 190 and a lower half section 195. The channel 130 may have a rectangular, circular, elliptical, or trapezoidal cross-sectional shapes. The channel 130 may be disposed in a horizontal planar manner. Alternatively, the channel may be disposed at any angle up to a vertically planar manner that provides for operating the fluid processes described herein. While the invention is described with reference to the figures of having two inlet ports and two fluid streams, the invention contemplates that the use of the design for three or more inlet ports and/or fluid streams.

The channel 130 may be a microfluidic channel having dimensions in the micrometer range. In such a micrometer range suitable channels 130 may have an average width between about 10 μm and about 1000 μm, such as between about 50 μm and about 500 μm, for example, about 100 μm and an average height between about 10 μm and about 500 μm, such as between about 20 μm and about 120 μm, for example, about 29 μm. Alternatively, the channel 130 may have a ratio of height to width of between about 1:25 and about 1:1, such as between 1:17, and 1:2.5, for example, about 13. Additionally, the channel 130 may have a radius of curvature between about 100 μm and about 1000 μm, such as between about 500 μm and about 700 μm, for example, about 630 μm. In a further alternative, the channel may have a hydraulic diameter between about 10 microns, and about 500 microns, such as between about 25 microns and about 100 microns as calculated from a hydraulic diameter, d, of d=4A_{c}/P, where 4A_{c} is the cross-sectional area and P is the wetted perimeter. One example of a microfluidic channel includes a width of 100 μm, a height of 29 μm, and a radius of curvature of about 630 μm. The invention further contemplates that the structures and processes described herein may be used for structures having dimension greater than and less than the microfluidic channels described herein and the examples herein should not be interpreting as limiting the structures herein.

The channel 130 includes a first curved channel section 140 and a second curved section 150. The channel 130 generally provides for a channel curve between about 90° and about 270°, for example, about 180°, with the first curved section 140 forming between about 20% and about 80%, such as about 50% of the curve, for example, about 90° of a 180° curve. The length of the respective curved sections 140, 150, may vary on the amount of desired rotation, with a rotation of at least 90° being preferred, the hydraulic diameter of the channel, and the flow conditions of the fluids. The length of the channel for a 180° will be about pi, π, times the radius of curvature of the channel. For a radius of curvature between about between about 100 μm and about 1000 μm, the length of the channel will be between about 314 μm and about 3142 μm.

The channel 130 further includes an outlet port 160 at the terminal end of the second curved channel section 150. The outlet port 160 may comprise an additional channel for transporting the fluid to a second channel structure, such as a second channel (not shown), or to another apparatus for further processing. The outlet port may form the inlet port of a second channel (not shown). In such a configuration, the second channel (not shown) may have a single inlet port of an outlet port 160 of the first channel 130. The second channel (not shown) may is disposed along the same plane as the first channel 130 with a curvature opposite of that of the first channel to provide a “S” shape or reverse “S” shape flow pattern. A third channel 130, or series of subsequent channels, may be connected to the outlet port 160 of the second channel having a curvature opposite (of 180°) of that of the prior channel, which can provide a multiple “S” shaped pattern referred to as a serpentine pattern. Alternatively, the outlet port 160 may connect to a straight channel (not shown) disposed between consecutive channels.

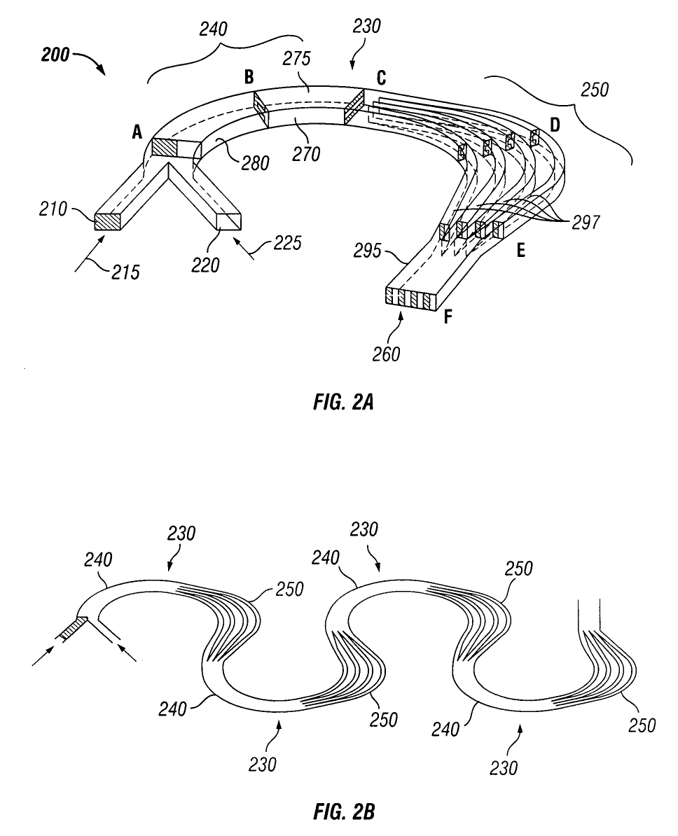

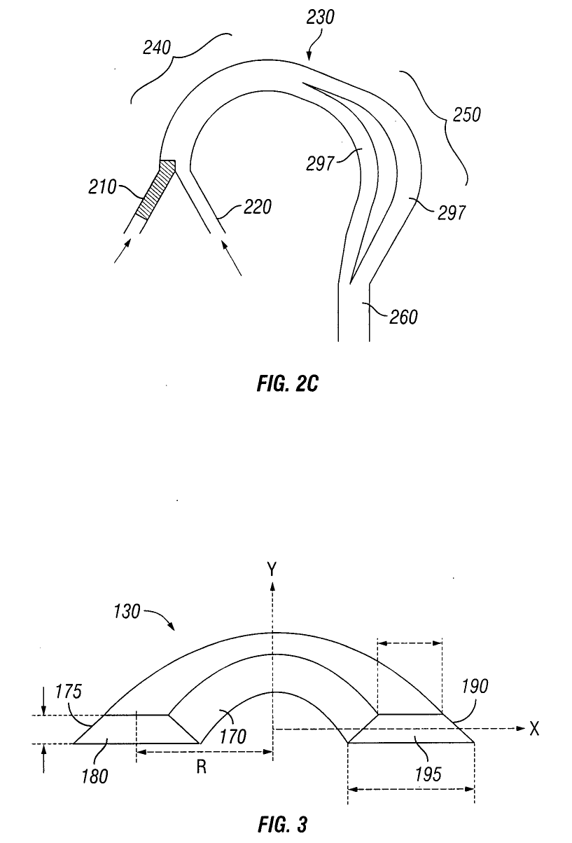

FIGS. 2A-2C disclose schematic views of anther embodiment of the fluid mixer 200 comprising a first inlet port 210 and a second inlet port 220 for providing a respective first fluid 215, shown as shaded, and a respective second fluid 225 to a channel 230 having two or more curved sections, such as a first curved channel section 240 and a second curved section 250. The channel 230 further comprises an inner wall 270 and an outer wall 275 defining a width, and a bottom 280 and a top 285 defining a height. The channel may be further defined as having an upper half section and a lower half section (not shown). The channel 230 provides a configuration having dimensions similar to channel 130 with the additional configuration for separating the fluid flow into several fluids flow and recombining the fluid flows at a point downstream in the channel 230. The fluid flow are may split into several planar flows that may be recombined on the same plane as the fluid flow from the first portion. In such a configuration, fluid from the inlet ports 210 is provided to the first channel section 240 and then is provided to the second channel section 250.

The second channel section 250 separates the fluid flow by two or more sub-channels 297. The second channel section 250 may have between 2 and 10 sub-channels, such as between 2 and 5 sub-channels, with configurations of 2 and 4 sub-channels preferred. The sub-channels 297 are may be provided to have equal widths and a combined width equal or substantially equal to the width of the first curved channel section 240 of channel 230 as shown in FIG. 2A. For example, in the four sub-channel configuration shown in FIGS. 2A-2B, the first curved channel section 240 has a width of about 400 μm and each of the four parallel or substantially parallel sub-channels 297 have a respective width of approximately 100 μm. Alternatively, the sub-channels 297 may have variable widths with a combined width of the equal or substantially equal to the width of the first curved channel section 240 of channel 230 as shown in FIG. 3. For example, in FIG. 2C, the first curved channel section 240 has a width of about 200 μm with an inner sub-channel 290 having a width of about 80 μm and an outer sub-channel 290 having a width of about 120 μm.

In one embodiment of the mixer 200, an inner sub-channel 297 retains the curvature of the channel 230. Alternatively, the sub-channels 297 may be designed along either side of an axis matching the curvature degree of the first section with each parallel sub-channel 290 having a different curvature. Additionally, the parallel sub-channels 297 may be of the same or different length depending on the configuration of channels and the respective widths.

The outlet port 260 may comprise a single channel formed from the respective sub-channels. The sub-channels 297 may have individual exit sections parallel to one another to form the outlet port at a single point, or alternatively, may have staggered or staged exit section that form an outlet port over a length of the channel 230 or a subsequent channel portion 295 separate from the channel 230 as shown in FIG. 2A.

The outlet port 260 may comprise an additional channel for transporting the fluid to a second channel structure, such as a second channel 230, or to another apparatus for further processing. The outlet port may form the inlet port 210 of a second channel 230. In such a configuration, the second channel 230 may have a single inlet port of an outlet port 260 of the first channel 230. The second channel 230 may is disposed along the same plane as the first channel 230 with a curvature opposite of that of the first channel to provide an “S” shape or reverse “S” shape flow pattern. A third channel 230, or series of subsequent channels, may be connected to the outlet port 260 of the second channel having a curvature opposite (180°) of that of the prior channel which can provide a multiple “S” shaped pattern referred to as a serpentine pattern as shown in FIG. 2B. Alternatively, the outlet port 260 may connect to a straight channel (not shown) disposed between consecutive channels 230.

An example of the channel 230 includes a first curved channel section 240 having a width of 400 μm, a height of 29 μm, and a radius of curvature of about 630 μm for about 1.2 millimeters, and a second curved channel section 240 having four sub-channels each having a width of 100 μm, a height of 29 μm, and a average radius of curvature of about 630 μm that are recombined in a staggered format at the end of the about 2.68 millimeters in length.

The channels 130, 230, 430, and 500 described herein may have a rectangular, circular, elliptical, or trapezoidal cross-sectional shape, of which a trapezoidal cross-section profile of a channel is shown in FIG. 3. The channel is may disposed in a horizontal planar manner. Alternatively, the channel may be disposed at any angle up to a vertically planar manner that provides for operating the fluid processes described herein. One example of a microfluidic channel includes a width of 150 μm and a height of 29 μm. The invention further contemplates that the structures and processes described herein may be used for structures having dimension greater than and less than the microfluidic channels described herein and the examples herein should not be interpreting as limiting the structures herein.

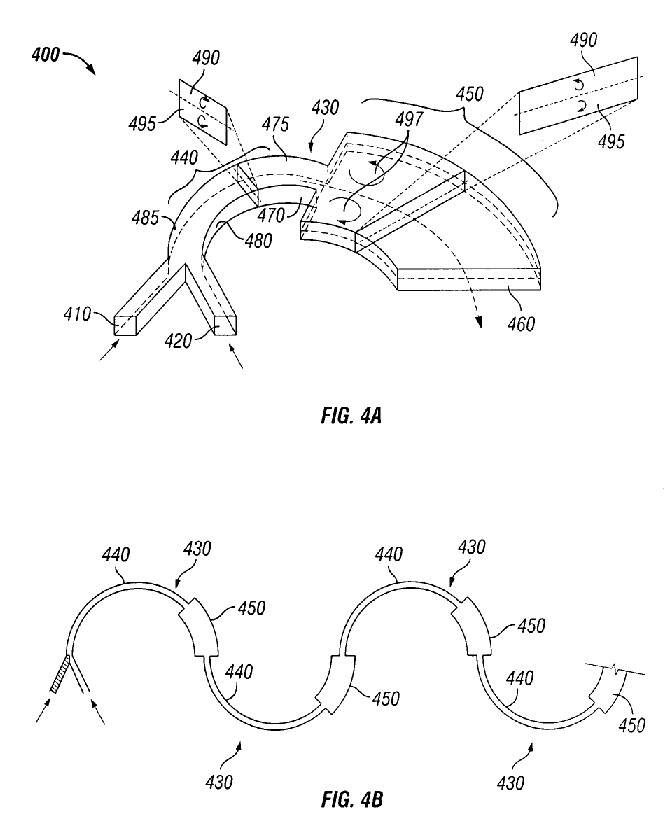

FIGS. 4A and 4B are schematic diagrams illustrating another embodiment of a fluid mixer 400 comprising a first inlet port 410 and a second inlet port 420 for providing a respective first fluid and a respective second fluid to a channel 430 having two or more curved sections, such as a first curved channel section 440 and a second curved section 450. The channel 430 further comprises an inner wall 470 and an outer wall 475 defining a width, and a bottom 480 and a top 485 defining a height. The channel may be further defined as having an upper half section 490 and a lower half section 495. The channel 400 has a configuration for an expansion second curved section 450 of the channel 400.

The second curved section 450 has a width greater than the first curved channel section 440 by a ratio of second width to first width of between about 3:2 and about 15:1, such as between about 2:1 and about 10:1, or between about 3:1 and about 7:1, for example, about 5:1. For example, the first curved channel section 440 may have a width of about 100 μm and a second curved section 450 width of about 500 μm. The second curved section 450 may has an expansion section having an immediate expansion from the width of the first curve section 440. The second curved section has a inner wall having a curvature corresponding to the first curved channel section 440 curvature. The second channel section 450 comprises between about 5% and about 50%, such as between about 15% and about 35%, for example, about 25% of the length.

The channel 400 has an outlet port with a third width less than or equal to the second width by a ratio of second width to third width of between about 1:1 and about 15:1, such as between about 2:1 and about 10:1, or between about 3:1 and about 7:1, for example, about 5:1. The third width may also have the same width as the first channel section 440 width. Subsequent channels having curvatures opposite the curvature of the prior channel 400 may be disposed subsequent to the first channel 400 in an “S” or reverse “S” pattern, which can provide a multiple “S” shaped pattern referred to as a serpentine pattern as shown in FIG. 4B.

Referring to FIGS. 1A-1B, the respective fluid streams 115, 125 may enter the channel 130 as parallel fluid streams under laminar flow conditions. The respective fluids may be provided at a flow rate to produce a Reynolds Number less than about 100, between about 1 and about 90, such as between about 10 and about 35 within a flow rate of between about 0.0005 ml/min and about 1 ml/min over a hydraulic diameter of the channel between about 1 micron and about 1000 microns. The hydraulic diameter, d, is calculated from d=4A_{c}/P, where 4A_{c} is the cross-sectional area and P is the wetted perimeter. Suitable fluids for use in the channels include fluids having a viscosity to produce the Reynolds number under the flow rate in channels having the hydraulic diameter described herein. While the channels and process described herein are made in reference to Reynolds Numbers less than 100, the invention contemplates that a Reynolds Number between 0.01 and 500 may be used herein.

Fluids entering a curvilinear channel experience inertial and centrifugal forces with the inertial forces directing bulk axial flow and centrifugal effects act in the direction of radius of curvature. The forces interplay to produce a radial pressure gradient that may be sufficient to generate a transverse secondary flow. The secondary transverse flows, also know as Dean flows, that arise as a result of centrifugal effects experienced by fluids traveling along a curved trajectory are characterized by the dimensionless Dean number (K=δ⁰⁵Re), where δ is the ratio of the channel hydrodynamic radius to the fluid flow path radius of curvature), and K expresses the ratio of inertial and centrifugal forces to viscous forces. These centrifugal effects induce a secondary flow field characterized by the presence of two counter-rotating vortices located above and below the plane of symmetry of the channel, coinciding with the channels plane of curvature.

The parallel fluid streams may be introduced into the channels 130 at a flow rate sufficient to produce a Dean's Number between about 1 and about 50, such as between about 3 and about 20, for example about 10 to produce at least a 90° rotation. The fluid flow into the channel 130 experience a Dean flow phenomena with two parallel fluid streams of different species, clear and shaded, entering a curved channel segment 140. The two parallel fluid streams experience unperturbed laminar flow at a low Dean Number, K, such as 1, as shown in FIG. 1A. At increasing Dean Numbers, such as about 10, an increasing transverse flow is generated by the counter rotating Dean vortices in the upper and lower halves of the channel section 140 as shown in FIG. 1B. The counter rotating Dean vortices transport the inner (clear) stream toward the outer wall while the outer (shaded) stream is pulled inward, causing the positions of each parallel fluid stream to be transposed at the exit with at least 90° rotations occurring in each curved section of the channel 130 respectively when the Dean Number is between about 3 and about 20. The respective rotation may be at least about 900, such as between about 90° to about 360°, or between about 90° to about 180°, for example, between about 90° to about 120°.

Reference points A-E illustrate the rotation phenomena as the first parallel fluid stream and the second parallel fluid stream are transposed as flowing through the channel 130. It is believed that the intrinsic rotational character of Dean flows increase interfacial area between fluid streams in the channels 130 and 230 as described herein. While the description herein recites at least 90° rotations, the invention contemplates that rotations less than 90°, such as at least 30°, and greater than 360° may be utilized with the mixers and processes described herein. The parallel first 115 and second streams 125 enter the curved channel 130 by respective inlet ports 110 and 120, and are shown as parallel fluid streams in the channel 130 at point A. The parallel fluid streams experience a transverse flow generated by the counter rotating vortices above and below the channel midplane at point B in the first curved channel section 140 resulting in at least 90° rotations, counter rotations respectively, in the respective fluids streams at from point A to C. The parallel fluid streams proceed along curved trajectories in the second curved channel section 150 to induce a second pair of at least 90° fluid rotations in each stream at point D. The two fluid streams are then transposed at the end of the second curved channel section 150 as shown at point E.

The transverse secondary flow associated with Dean effects can be characterized in terms of a dimensionless “Dean Number”, K, that expresses the relative magnitudes of inertial and centrifugal forces to viscous forces K=δ^{0.5}Re, where δ=d/R and R is the fluid flow path radius of curvature. Re=Vd/v with d as the channel hydraulic diameter d=4A_{c}/P, where 4A_{c} is the cross-sectional area and P is the wetted perimeter (the trapezoidal microchannel cross-sections were approximated as rectangular), Re is the Reynolds number, V is the fluid flow velocity, and v is the fluid kinematic viscosity. Microchannel Dean flows generally fall in the regime K<<100, where the secondary flow consists of a pair of counter rotating vortices positioned symmetrically above and below the channel midplane. At very low flow rates (K˜1) centrifugal effects are not strong enough to significantly perturb the axial laminar flow profile as shown in FIG. 1A. As the fluid flow rate is increased (K˜10) the transverse flow component acts to transport fluid from the inner wall of the channel radially toward the outer wall (FIG. 1B). Under these conditions (low curvature limit (δ<1), Re less than or equal to 100), the essential features of the secondary flow field are well described by Dean's solution to a perturbation analysis of the equations of motion. Centrifugal effects are greatest along the centerline where the axial velocity is maximum, resulting in outward flow along the midplane, while slower-moving fluid near the walls is simultaneously swept inward (FIG. IB). Ultimately, a nearly complete 180° rotation can be induced, causing two parallel fluid streams to almost entirely switch positions.

In the planar split-and-recombine channel configuration illustrated in FIGS. 2A-2C, the parallel liquid streams flow through the first curved channel section 240 that induces simultaneous counter rotations in the upper and lower halves of the first curved channel section 240. The initial rotation in the first curved channel section 240 provides for rotation of the parallel flows so that both fluids streams 215, 220 will be present in the two or more sub-channels 297 in the second curved channel section 250. The counter rotations may provide a rotation of at least about 90°, such as between about 90° to about 360°, or between about 90° to about 180°, for example, between about 90° to about 120°. The second curved section 250 splits the fluid flow from the parallel fluid streams into multiple streams in the respective sub-channels 297 that continue along curved trajectories such that each individual split stream experiences another pair of counter rotations in the upper and lower halves of the respective sub-channels 297. The successive rotation steps of each sub-channel 297 fluid streams transpose the position of each species such that alternating lamellae are formed when the streams are rejoined and are accompanied by a corresponding increase in interfacial area. It was observed that by employing a channel incorporating a series of four successive channel 230 elements as shown in FIG. 2B, a level of 90% mixing may be achieved.

Referring to FIGS. 2A-2B, in one example of a channel having sub-channels, a four channel second curved section is provided a planar geometry capable of generating alternating lamellae of individual fluid species in a split-and-recombine arrangement. The first curved channel is 400 μm wide, 29 μm tall, and has a 630 μm radius of curvature. Flow schematic of the respective parallel first stream (clear) and second stream (shaded) are shown at points A-F.

The parallel first and second streams enter the curved channel 230 by respective inlet ports 210 and 220, and are shown as parallel fluid streams in the channel 230 at point A. The parallel fluid streams experience a transverse flow generated by the counter rotating vortices above and below the channel midplane at point B resulting in at least 90° rotations, respective, in the respective fluids at point C, 1.2 mm downstream from entrance. The parallel fluid streams flow is split into four parallel fluid streams that proceed along curved trajectories at shown at point D to induce a second pair of at least 90° fluid rotations in each stream at point E. The alternating lamellae of the two fluid streams are generated when the two fluid streams are rejoined 4 mm downstream from the entrance at point F. FIG. 2B discloses a series of successive mixing elements of channels 200.

The length of the first curved channel section 240 and the length of the second curved channel section 250 are may designed to provide parallel fluid streams to the sub-channels 230 that have already induced simultaneous at least 90° counter rotations in the upper and lower halves of the first curved channel section 240. The lengths of the respective first and second curved channel sections will depend on channel geometry and flow conditions can be inferred by considering the relative timescales associated with the axial and transverse components of fluid motion.

The position and length of the second curved channel section for the sub-channels or expansion section is provided along the curved path so that the fluids streams have the inner fluid stream pulled the inner fluid across to the outside, which has may been rotated by at least 90°. The position and length can vary on the fluid flow parameters, channel size parameters, and the application requirements.

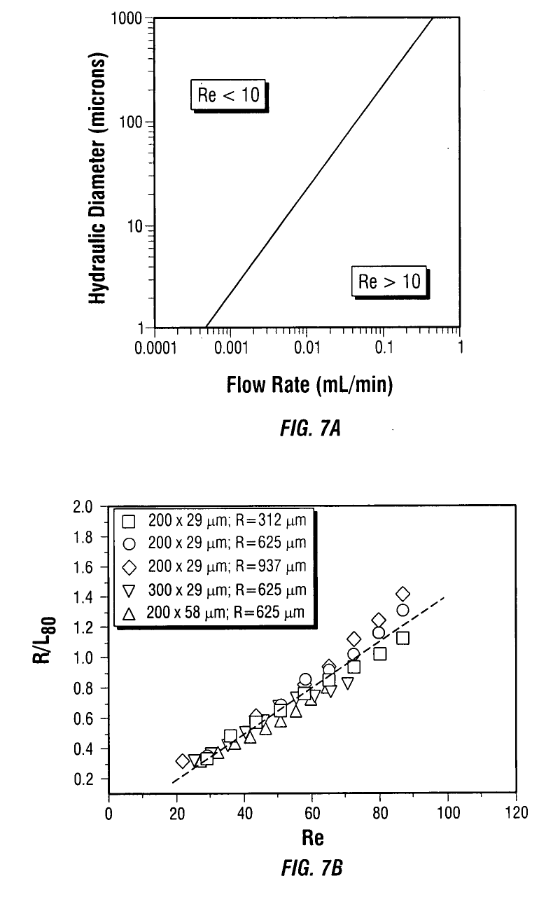

The position, and as such, the length, can be determined by first establishing a minimum Reynolds Number, and thus, Dean's Number, to provide for the at least 90° rotations in the first curved channel section. It has been experimentally observed that rotational effects providing for the at least 90° rotations in the channels described herein occur for Reynolds number greater than about 10. Next, at a known flow rate or a known hydraulic diameter of the channel, a design graph can be derived that illustrates regimes with the desired Reynolds Numbers. An example of such a graph that illustrates regimes where Re>10 in terms of flow rate and the hydraulic diameter of the channel as shown in the FIG. 7A. The x-axis of the graph in conjunction with a known flow rate (or alternatively, the y-axis with a known hydraulic diameter) will allow the range of channel diameters capable of producing the desired Re>10 to generate the desired rotation.

Axial transport can be approximated as laminar Poiseuille flow with characteristic velocity u_{A}˜U_{O} (the maximum centerline velocity), whereas the transverse (Dean flow) velocity scales as u_{D}˜Re(d/R)Uo. A ratio of corresponding timescales is then τ_{A}/τ_{D}˜(L_{A}/u_{A})/(L_{D}/u_{D})=(L_{A}/R)Re, where L_{A} and L_{D} are characteristic axial and transverse length scales, respectively, and L_{D} is taken to be the hydraulic diameter d. The downstream location at which a fluid element is transported across the width of the channel can then be estimated by setting τ_{A}/τ_{D}˜1, suggesting a linear scaling (R/L_{A})˜Re. This relationship is consistent with analysis of flow in macroscale helical pipes and is experimentally confirmed. Arbitrarily assigning L_{A} as the downstream location where transverse rotation effects pull the inner fluid outward to occupy 80% of the channel width (L₈₀), image analysis of data from approximately 50 experiments performed by using various combinations of R/L₈₀, Re, and cross-sectional dimensions superimpose and exhibit behavior consistent with a linear Re dependence. This scaling is shown by the linear fit to the experimental data plotted in FIG. 7B.

The length of the respective first and second curved channel section can then be determined at the given Re using the graph in FIG. 7B. The Reynolds Number linearly corresponds to a value of R/L on the y-axis where R is the radius of curvature and L is an estimate of the downstream distance for the 90 degree rotation. This ratio indicates where along the curved channel to form the second curved channel. For example, a value of a value of Re=30 corresponds to a value of R/L of 0.4 on the graph in FIG. 7B. Thus, the second curved channel having sub-channels or the expansion section can be formed at a length of the curved channel that is at least 2.5 times R. As shown in FIG. 7B, the length of the first section in a channel with radius of curvature R may be between about R/L=0.2 and about R/L=1.5 of the channel.

As such, it is estimated that the length of the first curved channel section is between about 0.5 times R and about 5 times R, such as between about 2 times R and about 3 times R, for a multiple channel second channel section; and that the length of the first curved channel section is between 0.5 times R and about 5 times R, such as between about 2 times R and about 3 times R, for a expansion second channel section. Further it was observed that in the curved sub-channels, the path length is about the same because the curved sub-channels follow the same curved path, however, the invention contemplates that the sub-channels may have different length and/or different degrees of rotation. For example, a second curved channel section may have 4 sub-channels with each sub-channel having a different length providing for different degrees of rotation.

Referring to FIG. 4A and 4B, a channel 400 having an expansion second curved channel section 450, has parallel flow being effected by expansion fluid dynamics. Such a channel may also be refereed to as an Asymmetric Serpentine Micromixer (ASM). Beyond a critical Re, fluid encountering a sudden increase in a channel's cross-sectional area undergoes local separation from the wall in response to the adverse pressure gradient resulting in the formation of a vortex pair bracketing the entrance to the expansion. For example FIG. 4A illustrates transverse Dean (vertical plane) vortices 490, 495 as described herein and the expansion (horizontal plane) vortices 497 in the vicinity of an abrupt increase in width. An example of such an expansion is from about 100 μm to 500 μm in the second curved channel section 450, which comprises about 25% of the length of the channel 400 that is 29-μm tall with a 630-μm radius of curvature.

When the expansion phenomena in the horizontal plane are coupled with Dean Number effects in the vertical plane in the same curved channel section, the resulting multivortex flow field can further accelerate interfluid transport. This effect has been observed by direct visualization of colored dye streams in a curved microchannel incorporating an expansion from 100 to 500 μm in width. With the use of a series of channels having the described expansion sections in a serpentine geometry, a level of 80% mixing is achieved at the 7.8-mm downstream position at Re=32.2, with even greater efficiencies are believed possible at higher flow rates. For aqueous working fluids, the ASM is capable of achieving a level of 80% mixing in downstream distances of less than about 7 mm at flow rates of greater than 10⁻¹ ml/min for a channel 430 having a first curved channel section 440 width of about 100 μm.

The length of the first curved channel section 440 and the length of the second curved channel section 450 are may designed to provide parallel fluid streams to the second curved channel section 450 that have already induced simultaneous 90° counter rotations in the upper and lower halves of the first curved channel section 440. This location can be determined by using the same analysis discussed for the channels described in FIGS. 2A-2C.

The expansion ratio of the second curved channel section 450 from the first curved channel section 440 (i.e., the ratio of outlet (wide) cross-sectional areas to inlet (narrow)) may be between about 1.5:1 and about 20:1, such as between about 2:1 and about 10:1, for example, about 5:1 as shown in FIG. 4A. Mixing in the second curved section 450 is effective where there is sufficient inertial driving force to generate transverse flow, such as at Re>1.

The degree of expansion can be determined by considering the friction loss accompanying a sudden expansion. For a sudden expansion fe=Ke(u2/2g), where fe is the friction loss for the case of incompressible inviscid flow along a streamline, u is the average velocity in the narrow (inlet) channel segment, and g is gravitational acceleration, and Ke is an expansion-loss coefficient given by Ke=(1−S₁/S_{b}), where Sₐ and S_{b} are the cross-sectional areas of the narrow (inlet) and wide (outlet) segments respectively. Thus, an increase in the value of Ke corresponds to an increase in friction loss, which serves as an indication of increased expansion vortex strength. It has been observed that vortex formation increased with increasing K numbers with flow rates ranging from 6.4<Re<32.2 (1.7<K<8.6) over a serpentine pattern series of channels 400. As K increases, it was observed that the two parallel fluid streams become almost completely intermixed.

The channels described herein can be fabricated in a single lithography step. This single step fabrication process makes the micromixing described herein applicable as generic components in a wide range of lab-on-a-chip systems, including those constructed in substrates where soft lithography cannot be used (e.g., glass, quartz, or silicon). For the experimental process described herein, master molds were fabricated by using a reported printed circuit-based soft lithography process. Channels in the micrometer range were constructed by heating the master to 120° C. on a hot plate and making an impression of the pattern in a melt-processable thermoplastic elastomer gel substrate. After cooling and release, fluidic access holes were fashioned by using a syringe needle, and the channels were thermally bonded to a flat surface of the elastomer to form enclosed channel networks.

Observation of the streams was coordinated by cross-sectional images of two aqueous streams, one of which was labeled with fluorescent Rhodaniine 6G (Aldrich), were obtained by using a LSM 5 PASCAL confocal scanning microscope (Zeiss) with a 40×, 0.6 numerical aperture objective. Mixing efficiency was quantified by computing the standard deviation of the intensity distribution over each image, σ=(I−[I])₂, where I is the grayscale value of each pixel (scaled between 0 and 1) and [] denotes an average over all of the pixels in the image. Thus, σ=0.5 corresponds to two completely unmixed regions whereas σ=0 corresponds to complete mixing. Top-view images of aqueous streams labeled with blue and yellow food dye (Adams Extract, Gonzales, Tex.) were obtained by using a MZ8 microscope (Leica) interfaced with a Coolpix 4500 digital camera (Nikon). Flow rates were controlled by using a multifeed syringe pump (Harvard Apparatus).

Binding experiments were carried out between two aqueous streams, one containing 50 μg/ml calf thymus DNA (Sigma-Aldrich) and the other containing 2.5 μg/ml ethidium bromide (Maxim Biotech, South San Francisco, Calif.). Fluorescence was detected by using an Olympus SZX-12 stereoscope with a mercury arc illumination source and GFP filter set and imaged by using a CCD-300 camera with Geniisys intensifier (Dage-MTI, Michigan City, Ind.).

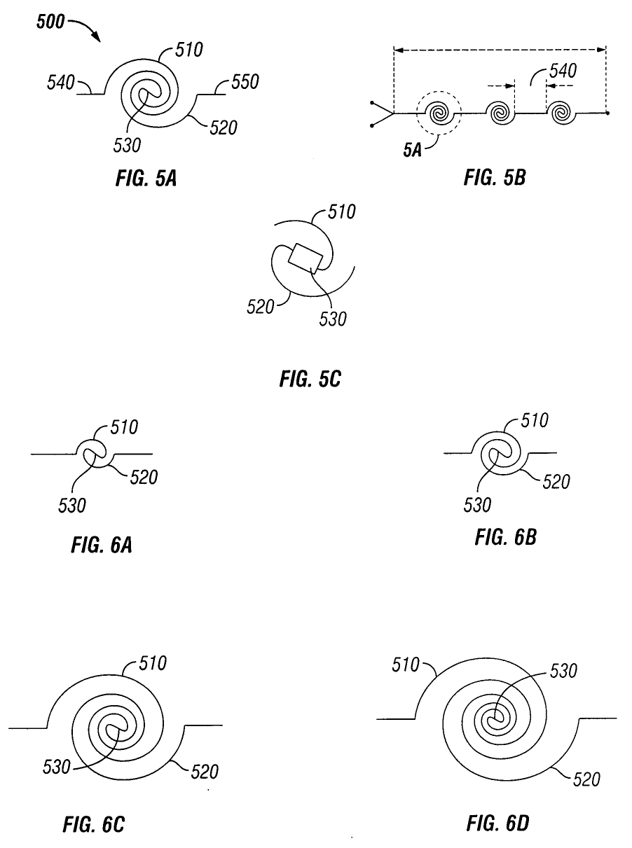

FIGS. 5A-5B disclose schematic perspective and cross-sectional views of one embodiment of a fluid mixer 500 comprising an first curved channel section 510, a second curved section 520, and a transition section 530 between the first curved channel section 510 and the second curved section 520. The fluid mixer 500 may further comprise one or more inlet ports 540 connected to the first curved channel section 510 either directly or indirectly along a fluid path for providing two or more fluids to the channel 500, and an outlet port 550 connected to the second curved section 520. The channel 500 has a inner wall 570, an outer wall 575, a bottom 580. The channel may be further defined as having an upper half section 590 and a lower half section 595. The one or more inlet ports 540 generally have an aggregate width matching the width of the channel 500.

The channel 530 may have an average width between about 10 μm and about 1000 μm, such as between about 50 μm and about 500 μm, for example, about 100 μm and an average height between about 10 μm and about 500 μm, such as between about 20 μm and about 120 μm, for example, about 30 μm. Alternatively, the channel 130 may have a ratio of height to width of between about 1:25 and about 1:1, such as between 1:17, and 1:2.5, for example, about 13. In a further alternative, the channel 530 may have a hydraulic diameter between about 10 microns, and about 500 microns, such as between about 25 microns and about 100 microns as calculated from a hydraulic diameter, d, of d=4A_{c}/P, where 4A_{c} is the cross-sectional area and P is the wetted perimeter.

In one embodiment, the first curved channel section 510 of the channel 500 comprises two circular arcs providing for fluid flow in 180°. The arcs may have a radius of curvature between about 100 μm and about 5000 μm, such as between about 400 μm and about 3000 μm. In a second embodiment of the first curved channel section 510, the first curved channel section 510 comprises two or more circular arcs having a radius of curvature decreasing between about 10% and about 100%, such as between about 50% and about 90%, for example, about 80%, for each 90° arc. The two or more arcs may form an inward semi-spiral or inward spiral portion.

In one embodiment of the second curved channel section 520 of the channel 500, the second curved channel section 520 comprises two circular arcs providing for fluid flow in 180°. The 90° arcs may have a radius of curvature between about 100 μm and about 5000 μm, such as between about 400 μm and about 3000 μm. In a second embodiment of the second curved channel section 520, the second curved channel section 510 comprises two or more circular arcs having a radius of curvature increasing between about 5% and about 50%, for example, about 25%, for each 90° arc. The two or more arcs may form an outward semi-spiral or outward spiral.

The transition section 530 disposed between the first and second curved channel sections 510 and 520, may comprise a straight channel, a curved channel, a multiple curve channel, such as a “S” shaped channel, a expansion region, or combinations thereof. The transition section is provided to separate sections 510 and 520 by a sufficient distance to allow the first curved section and the second section to respectively inwardly spiral and outwardly spiral without the crossing of the sections. As, such the transition section size and length will vary based on the design of spiral pattern including the length of the spiral, the size parameters of the channel, the number of arcs of the spiral, the curvature of the transition section, if any, and degree of the decrease or increase in the radius of curvature. In one embodiment of the transition section, the transition section has a distance between about 0.25 mm and about 2 mm, for example, 1 mm, for a channel having a spiral footprint in the millimeter range. Alternatively, the transition section separates the first curved channel section and the second curved channel section between about 50% and about 95%, such as between about 70% and about 90%, for example, about 83.3% of the distance between the beginning of the inner most arc and the end (180°) of the inner most arc.

The straight channel, curved channels, or multiple curved channels of the transition section 530 comprise the width and height of the channel 500. The transition section 530 may comprise an expansion region as shown in FIG. 5D. The expansion region of the transition section 530 has a width greater than the width of the first curved channel section 510 by a ratio of maximum transition section width to first curved channel section width of between about 3:2 and about 15:1, such as between about 2:1 and about 10:1, or between about 3:1 and about 7:1, for example, about 5:1. For example, the first curved channel section 510 may have a width of about 80 μm and the transition section 530 may have maximum width of about 400 μm. The transition section 530 may have has an expansion section having an immediate expansion from the width of the first curve channel section 510.

Examples of the spiral channels of five different lengths were designed with the longest incorporated ten arcs on each spiral and the shortest section had two arcs on each spiral. Details of the examples are illustrated in Table 1 and shown in FIGS. 5A for a 6 arc spiral and 6A-6D for 2, 4, 8, and 10 arc spirals, respectively. All spiral channels were 150 μm wide and 29 μm tall. The hydraulic diameter of the channel is calculated to be 49 μm and is taken as the characteristic cross-sectional dimension.

TABLE 1

| | | | Length of | Length of | Footprint of |
|---|---|---|---|---|---|
| | | Max. Radius | Inlet/outlet | Mixing | Mixing |
| Spiral | Arcs on | of Curvature | Spiral | Section | Section |
| Design | Spiral | (mm) | (mm) | (mm) | (mm) |
| 1 | 2 | 0.52 | 1.47 | 3.97 | 1.2 × 1.0 |
| 2 | 4 | 0.81 | 3.77 | 8.57 | 1.7 × 1.5 |
| 3 | 6 | 1.27 | 7.35 | 15.73 | 2.9 × 2.3 |
| 4 | 8 | 1.98 | 12.96 | 26.95 | 4.4 × 3.6 |
| 5 | 10 | 3.10 | 21.73 | 44.49 | 6.9 × 5.5 |

A fluid mixing design may incorporate multiple channels 500 in sequence as shown in FIG. 5B. Individual channels 500 may be connected by channel segments 540 that may be straight or curved in shape. The channel segments may have a length between about 100 micron and about 10 mm, for example, 3 mm. Alternatively, the channel segments 540 may be related to the size of the foot print, such as the channel length being between about 0.1 and about 10 times the size of the largest footprint, such as between about 0.5 and about 3 times the size of the largest footprint, for example, about the same size (1 times the size) of the largest footprint parameter. For example, the 6 arc spiral from Table 1 has a footprint of about 2.9 mm×2.3 mm, and may be separated by a straight channel segment 540 of about 3 mm in length. Alternatively, the individual channels 500 may be directly connected to one another with the subsequent channel having an orientation of about 180° to the prior channel 500 orientation.

The channels 500 described herein may process fluids having Reynolds numbers (Re) less than 100, such as between about 0.1 and about 50, for example, between about 0.19 and about 18.6, and with Dean numbers (K) between about 0.01 and about 15, such as between about 0.024 and about 5.1. It was also further observed that as the radius of curvature decreases in the first channel curved section 510, the Dean number increases due to a corresponding increase in the value of δ, and a corresponding reverse relationship was observed as the radius of curvature increases in the second channel curved section 520, the Dean number decreases due to a corresponding decrease in the value of δ.

In conventional planar straight microchannel geometries, any mixing that occurs is purely by diffusion. In curved channels, transverse secondary Dean flows arise as a result of the interplay between inertial and centrifugal forces as the fluid travels from the outer to the inner regions of the spiral path where the radius of curvature is smallest. Additionally, the direction of rotation of the secondary flows is sustained over the entire length of the spiral as compared to designs incorporating alternating segments of opposing curvature as described herein. Further it is believed that since the channels are in a spiral format, the necessary length required to achieve appreciable levels of mixing by diffusion can be increased, while at the same time keeping the overall footprint of the channel at a minimum as shown in Table 1. Thus, it is believed that with increasing flow rate (Re>10), the secondary flows become stronger and greatly increase the extent of mixing under both low and high flow rates. Further, as fluid travels downstream inside the spiral contours, it experiences an increase in the magnitude of centrifugal forces accompanied by a corresponding enhancement in mixing performance.

Mixing intensity between a channel design of a series of three channels 500, having 2 arcs on each spiral, and separated by two straight channel segments and straight channels of equal length were compared for Reynolds Numbers between 0.02 and 18.6. An example of such a configuration is shown in FIG. 5B. At 4 mm, the end of the first channel 500, the channel design had a mixing intensity between about 55% and about 65% over the range of Reynolds Numbers, and the corresponding straight channel had a mixing intensity of less than 15%. At 12 mm, the end of the second channel 500, the channel design had a mixing intensity between about 65% and about 85% over the range of Reynolds Numbers, and the corresponding straight channel had a mixing intensity of less than 25%. At 19 mm, the end of the third channel 500, the channel design had a mixing intensity between about 85% and about 95% over the range of Reynolds Numbers, and the corresponding straight channel had a mixing intensity of less than 35%. It was observed that unlike straight channels, the mixing length becomes shorter with increasing Re, as expected based on the fact that the Dean number (and hence the strength of the secondary flow promoting mixing) is directly proportional to Re.

Mixing intensity was observed for channels having 4, 6, 8, and 10 arcs for the first curved section. The 4 arc first curved channel section channel having a first curved channel section length of approximately 4 mm exhibited a mixing intensity of between about 55% and about 75% for Reynolds Numbers over the range of 0.02 to 18.6. The 6 arc first curved channel section channel having a first curved channel section length of approximately 9 mm exhibited a mixing intensity of between about 60% and about 80% for Reynolds Numbers over the range of 0.02 to 18.6. The 8 arc first curved channel section channel having a first curved channel section length of approximately 14 mm exhibited a mixing intensity of between about 70% and about 90% for Reynolds Numbers over the range of 0.02 to 18.6. The 10 arc first curved channel section channel having a first curved channel section length of approximately 20 mm exhibited a mixing intensity of between about 65% and about 90% for Reynolds Numbers over the range of 0.02 to 18.6.

It was observed that the increasing length of individual spiral contours provided higher levels of mixing within the first spiral section. It is believed that the increased length not only provides a longer time for diffusion at slow flow rates, but also helps in sustaining the transverse secondary flow. It was observed that the strength of the transverse secondary flows is at a maximum in the arcs with the smallest radius of curvature (i.e., in the central region of the spiral), and at higher flow rates, the most mixing is expected to occur in these segments. It was observed that most mixing occurs at the innermost region of the spiral flow path.

The mixing intensity was observed for channels having 4, 6, 8, and 10 arcs for the first curved section that were disposed in a series of three channels separated by two straight channel segments. In the four-arc channel, mixing levels of 90% are achieved at the end of the second channel section, whereas in the eight- and ten-arc channels 90% mixing is obtained at the end of the first channel section.

A channel 500 having a width of 80 μm with an expansion connecting section of a straight segment that is 400 μm wide as shown in FIG. 5D, was observed to have a jet-like motion as the fluid encounters this sudden expansion in cross-sectional area, and forms a pair of vortices develop at the entrance of this expansion on either side of this jet stream. The vortices become asymmetric with increasing Reynolds Numbers. The combined effects of the expansion vortices with transverse Dean vortices result in a rapid increase of the mixed interface between two parallel fluid streams.

The arc channel designs 500 described herein may be fabricated in a single lithography step. The channel 500 designs incorporating spiral structures were designed using Adobe Illustrator (Adobe Systems Incorporated; San Jose, Calif.), and then printed on transparency film with a 3166 dpi printer (Mika Color; Los Angeles, Calif.) to produce photomasks. PC boards were purchased pre-coated with a positive tone photoresist (1 oz copper foil: Circuit Specialists Inc.; Mesa, Ariz.) and exposed to UV illumination through the photomask for 90 s (approximate flux 4.5 mW cm′) to transfer the pattern onto the PC board. Following exposure, the PC boards were immersed for 90-120 s under gentle agitation in a developer solution prepared by mixing 3.5 mL of a 50% w/w aqueous sodium hydroxide solution (Fisher Scientific; Hampton, N.H.) with 500 mL of deionized water. Next, the PC boards were transferred to a plastic vertical tank containing an etching solution prepared by dissolving 150 g of ammonium peroxydisulfate crystals (certified ACS grade; Fisher Scientific; Hampton, N.H.) in 1 L of deionized water to etch away the underlying copper foil in the patterned areas. The etching tank was mounted on a hotplate in order to maintain the solution at a temperature of 40-55 C, and an air pump was used to provide continuous agitation. After the etching process was completed, the remaining photoresist masking the channel structures was stripped with acetone. The height of the channel structures (equivalent to the thickness of the copper foil) was measured to be 29 μm using a stylus profilometer.

Microfluidic devices were then fabricated using a melt processable thermoplastic elastomer that was synthesized by combining commercially available polystyrene-(polyethylene/polybutylene)-polystyrene (SEBS) triblock copolymers (e.g. CP-9000, Kraton-G series) in mineral oil (light mineral oil; Fisher Scientific; Hampton, N.H.) Resin and mineral oil (33 wt % copolymer) were mixed and placed under vacuum overnight at room temperature in order to allow the oil to evenly coat the resin surface. The mixture was then heated to 170° C. under vacuum for four hours to allow the resin and oil to intermix and to remove any residual air pockets. Finally, the mixture was cooled to room temperature and the solidified gel was cut into smaller pieces and placed on top of the PC board master mold that had been preheated to 120° C. on a hot plate. Once the elastomer began to soften, a glass plate was placed on top of the slab and gentle pressure was applied by hand to ensure complete contact with the structures on the mold. After cooling and release, the solidified gel incorporates the shape of the structures on the master. Fluidic access holes were made using a syringe needle, and the molded slab was thermally bonded to a flat surface of the elastomer to form enclosed channel networks.

Flow studies were carried out by imaging parallel aqueous streams labeled with blue and yellow food dyes (Adams Extract; Austin, Tex.) diluted to 0.01 g/mL of water. Flow rates ranging from 0.0001 to 0.1 mL/min (corresponding to Re 0.02 to 18.6) were controlled using a multi-feed syringe pump (Harvard Apparatus; Houston, Mass.). The devices were interfaced with the syringe pump using Teflon tubing (Small Parts Inc.; Miami Lakes, Fla.). Digital images of the fluid flow were obtained using a MZ 8 microscope (Leica Microsystems Inc.; Bannockburn, Ill.) interfaced with a Coolpix 4500 digital camera (Nikon). This interface was achieved using a digital camera C-mount coupler (Thales Optem Inc.; Fairport, N.Y.). The extent of mixing was determined by the amount of green color that was generated when the two streams mixed. The digital images were imported into Adobe Photoshop (Adobe Systems Inc., San Jose, Calif.) where the green color was filtered out and the images were converted to gray-scale and inverted. Mixing intensity was then calculated using the following equation.

While the foregoing is directed to various embodiments of the invention, other and further embodiments of the invention may be devised without departing from the basic scope thereof and the scope thereof is determined by the claims that follow.

What is claimed is:

1. A fluid mixer, comprising:
one or more fluid inlet ports,
a curved channel connected to the one or more fluid inlet ports, comprising:
a first curved channel section, and
a second curved channel section disposed adjacent the first curved channel section; and
an outlet port disposed adjacent the second curved channel section.

2. The fluid mixer of claim 1, further comprising one or more curved channels subsequently disposed from the curved channel and each of the subsequent one or more curved channels having a curvature opposite the prior curved channel.

3. The fluid mixer of claim 1, wherein the second curved channel section comprises two or more sub-channels.

4. The fluid mixer of claim 3, wherein the first curved channel has a first width and the aggregate width of the two or more sub-channels is equal to the first width.

5. The fluid mixer of claim 3, wherein the two or more sub-channels each have equal widths.

6. The fluid mixer of claim 3, wherein an innermost sub-channel has a radius of curvature of the first curved channel section.

7. The fluid mixer of claim 3, wherein the two or more sub-channels combine at the outlet port.

8. The fluid mixer of claim 1, wherein the first curved section has a first width and the second curved channel section has a second width greater than the first width.

9. The fluid mixer of claim 8, wherein the second width to first width ratio is between about 2:1 and about 10:1.

10. A fluid mixer, comprising:
one or more fluid inlet ports;
a channel section connected to the one or more fluid inlet ports, the channel section comprising,
an inlet arc section connected to the one or more inlet ports;
a transition section connected to the inlet arc section;
an outlet arc section connected to the transition section; and
an outlet port connected to the outlet arc section.

11. The fluid mixer of claim 10, wherein the inlet arc section comprises two or more arcs.

12. The fluid mixer of claim 10, wherein the inlet arc section comprises two or more arcs each having a decreasing radius of curvature between about 10% and less than about 100%.

13. The fluid mixer of claim 12, wherein the inlet arc section comprises two or more arcs in an inward spiral pattern.

14. The fluid mixer of claim 10, wherein the outlet arc section comprises two or more arcs each having an increasing radius of curvature between about 10% and less than about 100%.

15. The fluid mixer of claim 14, wherein the outlet arc section comprises two or more arcs in an outward spiral pattern.

16. The fluid mixer of claim 10, wherein the inlet arc has a first width and the transition section has a second width greater than the first width.

17. The fluid mixer of claim 10, further comprising two or more channel sections sequentially connected to the first channel section.

18. A method for mixing fluids in a channel, comprising:
providing a channel having one or more fluid inlet ports, an inner channel wall, an outer channel wall, an upper channel half, a lower channel half, a first curved channel section, and a second curved channel section;
providing two or more parallel fluid streams into the second curved channel section of the channel;
mixing the two or more parallel fluid streams in the first curved channel section of the channel; and
mixing the two or more parallel fluid streams in the second curved channel section of the channel.

19. The method of claim 18, wherein the providing the two or more parallel fluid streams comprises providing a first parallel fluid stream and a second parallel fluid stream to the channel by the one or more fluid inlet ports, and the first parallel fluid stream is provided adjacent the inner channel wall and the second parallel fluid stream is provided adjacent the outer channel wall.

20. The method of claim 18, wherein the mixing the two or more parallel fluid streams in the first curved channel section of the channel comprises:
inducing at least a 90° rotation to the first parallel fluid stream and the second parallel fluid stream in the upper channel half of the first curved channel section; and
inducing at least a 90° counter rotation to the first parallel fluid stream and the second parallel fluid stream in the lower channel half of the first curved channel section;

21. The method of claim 18, wherein the mixing the two or more parallel fluid streams in the second curved channel section of the channel comprises:
inducing at least a 90° rotation to the first parallel fluid stream and the second parallel fluid stream in the upper channel half of the second curved channel section; and
inducing at least a 90° counter rotation to the first parallel fluid stream and the second parallel fluid stream in the lower channel half of the second curved channel section; and

22. The method of claim 18, further comprising transporting the first parallel fluid stream and the second parallel fluid stream to a second channel with the first parallel fluid stream is disposed adjacent the outer channel wall and the second parallel fluid stream is disposed adjacent the inner channel wall.

23. The method of claim 18 wherein the first parallel fluid stream and the second parallel fluid stream have a Reynolds number between about 1 and less than about 100.

24. The method of claim 18, wherein the mixing the two or more parallel fluid streams in the second curved channel section of the channel comprises:
providing the two parallel fluid streams to two or more sub-channels disposed in the second curved channel section;
inducing at least a 90° rotation to the first parallel fluid stream and the second parallel fluid stream in an upper channel half of each of the two or more sub-channels; and
inducing at least a 90° counter rotation to the first parallel fluid stream and the second parallel fluid stream in a lower channel half of each of the two or more sub-channels; and

25. The method of claim 24, further comprising recombining the first parallel fluid stream and the second parallel fluid stream from the two or more sub-channels.

26. The method of claim 18, wherein the mixing the two or more parallel fluid streams in the second curved channel section of the channel comprises:
providing the two parallel fluid streams to the second curved channel section having a width wider than the first curved channel section;
exposing the two parallel fluid streams to expansion vortices;
inducing at least a 90° rotation to the first parallel fluid stream and the second parallel fluid stream in the upper channel half of the second curved channel section; and
inducing at least a 90° counter rotation to the first parallel fluid stream and the second parallel fluid stream in the lower channel half of the second curved channel section.
